(19) United States
(12) Patent Application Publication
(10) Pub. No.: US 2005/0155999 A1
(43) Pub. Date: Jul. 21, 2005

(54) Sport equipment rack

(76) Inventor: Daniel L. Gasper, Merced, CA (US)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 10/759,844

(22) Filed: Jan. 15, 2004

(51) Int. Cl. B60R 7/00; B60R 9/00

(52) U.S. Cl. 224/406

(57) ABSTRACT

A sport equipment rack is provided for releasably holding sport equipment within a boat. The sport equipment rack includes a support member having a longitudinal axis and including a base, a guide extending along the longitudinal axis from the base, and a support prong extending from the base at an angle with respect to the longitudinal axis, a clamp member movable along the guide between an open position and a secured position, the clamp member having a wedge surface substantially parallel to the support prong defining a variable width slot between the wedge surface and the support prong dimensioned to receive the sport equipment, a resilient gripping member disposed on the support prong facing the wedge surface, and a securing device configured to move the clamp member between the open and secured positions, whereby the wedge surface is configured to bias sport equipment against the support prong as the clamp member moves toward the closed position. A method of using the sport equipment rack is also disclosed.

### BACKGROUND OF THE INVENTION

1. Field of the Invention

This invention relates, in general, to a sport equipment rack for a watercraft and more particularly to wake board rack for a boat, as well as methods for the use thereof.

2. Description of Related Art

Watersports such as wake boarding and knee boarding have become quite popular. While some newer boats may have special provisions for storing and holding the sport equipment required by a particular watersport, some newer boats and most older boats do not. Instead, the sport equipment is merely placed in the boat, often on the floor, and may jostle and otherwise move during the operation of the boat, particularly when suddenly accelerating or decelerating, sharply turning, and/or traveling over choppy water.

Attempts have been made to provide fork-type racks having slots that are dimensioned to receive and hold the sport equipment within the slots. An exemplar of the prior art is U.S. Pat. No. 5,906,304 to Baldacchino which shows a water sport equipment rack including a pair of planar members 10 having a plurality of slots 20, 21, 22 for holding water skis, wake boards, knee boards or the like. While such prior racks are configured hold sport equipment in a particular location within a boat, the racks do not secure the sport equipment to the rack. In particular, the sport equipment mayjostle or otherwise move within and/or fall out of such prior racks unless a strap such as a bungee cord or other means is used to secure the sport equipment to such prior racks.

Some prior racks have been configured to releasably secure the sport equipment to the rack. For example, U.S. Pat. No. 5,752,638 to Meeks shows a combination water ski and wake board rack that, unlike the rack disclosed by the Baldacchino patent, utilizes straps 48 to retain skis 49 in the rack.

Disadvantageously, the straps used in combination with prior racks may be damaged or lost, rendering the rack ineffective to securely hold the sport equipment. What is needed is a new and improved sport equipment rack that overcomes the above and other disadvantages of known fork-type racks.

### BRIEF SUMMARY OF THE INVENTION

One aspect of the present invention is directed to a rack for releasably holding sport equipment including a support member having a base, a guide extending from the base, and a support prong extending from the base angularly disposed with respect to the guide, a clamp member movable along the guide between an open position and a secured position, the clamp member having a wedge surface substantially parallel to the support prong, and a securing device configured to move the clamp member between the open and secured positions, whereby the wedge surface is configured to bias sport equipment against the support prong as the clamp member moves toward the closed position.

Preferably, the rack is dimensioned and configured to hold a wake board, a knee board, a surf board, and/or water skis. The support member may include a pair of support prongs and the clamp member may include a corresponding pair of wedge surfaces. The pair of support prongs may be substantially symmetrically arranged about the guide and the pair of wedge surfaces may be substantially symmetrically arranged about the guide.

Preferably, the rack includes a pair of the support members and a corresponding pair of clamp members. The rack may further include a cross brace having two ends, and each the supporting members may be attached to the cross brace adjacent a respective end. The rack may further include a mount for securing the rack to a watercraft. The mount may be disposed on the cross brace intermediate the ends.

In one embodiment, the rack further includes a resilient gripping member disposed on a support surface of the support prong facing the wedge surface. The gripping member may include a lug extending toward the wedge surface when the clamp member is in the open position, and the lug may be configured to flex toward the base as the clamp member is moved to the closed position. The gripping member may include a plurality of the lugs.

The securing device may include a securing lever and a securing rod operably connected to the securing lever. Preferably, the securing rod extends through the support member and is operably coupled to the clamp member. Preferably, the closed position is adjustable to accommodate sport equipment of various widths. In one embodiment, the securing rod has a threaded end adjustably coupled to a threaded pin of the securing lever.

Another aspect of the present invention is directed to a rack for releasably holding sport equipment including a support member having a longitudinal axis and a base, a guide extending along the longitudinal axis from the base, and a support prong extending from the base at an angle with respect to the longitudinal axis, a clamp member movable along the guide between an open position and a secured position, the clamp member having a wedge surface substantially parallel to the support prong defining a variable width slot between the wedge surface and the support prong dimensioned to receive the sport equipment, a resilient gripping member disposed on the support prong facing the wedge surface, and a securing device configured to move the clamp member between the open and secured positions, whereby the wedge surface is configured to bias sport equipment against the support prong as the clamp member moves toward the closed position.

Preferably, the rack is dimensioned and configured to hold a wake board, a knee board, a surf board, and/or water skis. The support member may include a pair of support prongs and the clamp member may include a corresponding pair of wedge surfaces. The pair of support prongs may be substantially symmetrically arranged about the longitudinal axis and the pair of wedge surfaces may be substantially symmetrically arranged about the longitudinal axis.

Preferably, the rack includes a pair of the support members and a corresponding pair of clamp members. The rack may further include a cross brace having two ends, and each the supporting members may be attached to the cross brace adjacent a respective end. The rack may further include a mount for securing the rack to a watercraft. The mount may be disposed on the cross brace intermediate the ends.

In one embodiment, the rack further includes a resilient gripping member disposed on a support surface of the support prong facing the wedge surface. The gripping member may include a lug extending toward the wedge surface when the clamp member is in the open position, and the lug may be configured to flex toward the base as the clamp member is moved to the closed position. The gripping member may include a plurality of the lugs.

The securing device may include a securing lever and a securing rod operably connected to the securing lever. Preferably, the securing rod extends through the support member and is operably coupled to the clamp member. Preferably, the closed position is adjustable to accommodate sport equipment of various widths. In one embodiment, the securing rod has a threaded end adjustably coupled to a threaded pin of the securing lever.

An object of the present invention is to provide a sport equipment rack for releasably securing a variety of sport equipment including, but not limited to a wake board on a boat.

The sport equipment rack of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is a perspective view of a sport equipment rack mounted on a boat and supporting a pair of wake boards in accordance with the present invention.

FIG. 2 is a front perspective view of the sport equipment rack of FIG. 1 in a open position.

FIG. 3 is a rear perspective view of the view of the sport equipment rack of FIG. 1 in the open position.

FIG. 4 is a rear perspective view of the sport equipment rack of FIG. 1 in a closed position.

FIG. 5 is a side view of the sport equipment rack of FIG. 1 in the closed position with one wake board, schematically shown in phantom, secured on the rack.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

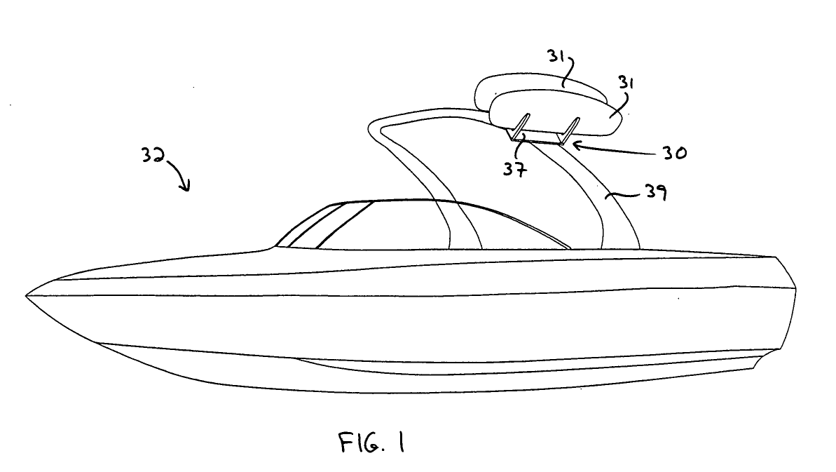

Turning now to the drawings, wherein like components are designated by like reference numerals throughout the various figures, attention is directed to FIG. 1 in which a sport equipment rack in accordance with the present invention, generally designated 30, is mounted to a boat. In the illustrated embodiment, the rack is dimensioned and configured to releasably secure a pair of wake boards 31 to a boat 32. One will appreciate, however, that the sport equipment rack of the present invention may be dimensioned and configured to be utilized in combination with a variety of sport equipment including, but not limited to knee boards, water skis, ski booms and the like. In addition, the sport equipment rack may be configured to secure sport equipment to other types of vehicles. For example, the sport equipment rack may be dimensioned and configured to secure surf boards, snow skis and other equipment to land vehicles including, but not limited to automobiles, pick-up trucks, sport utility vehicles, snow mobiles and the like.

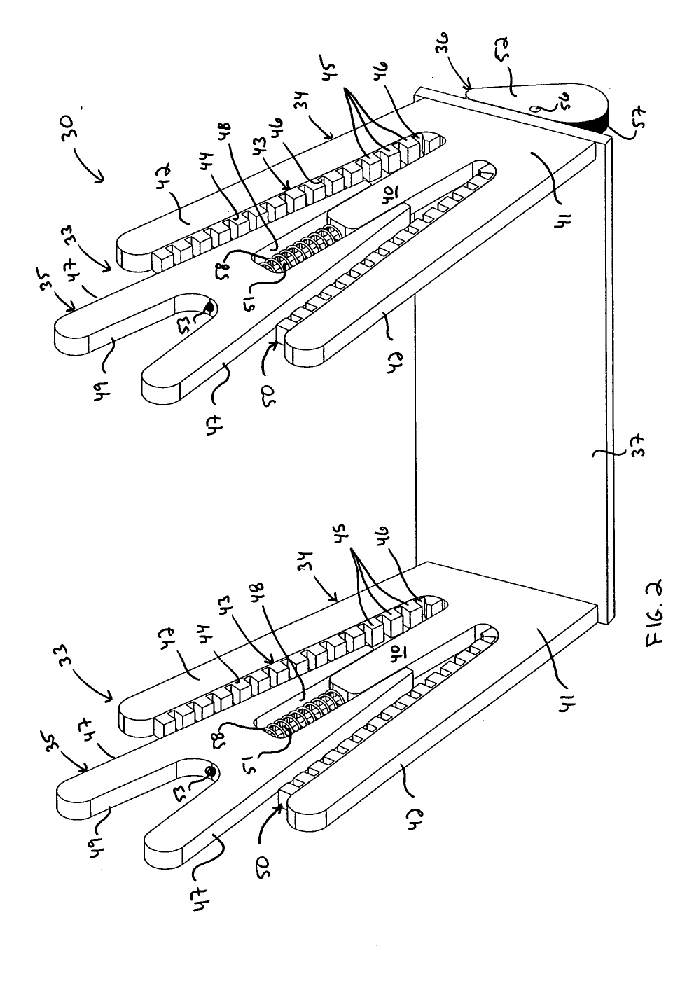

Generally, sport equipment rack 30 includes a clamping assembly 33 having a support member 34, a clamp member 35 and a securing device 36. In the illustrated embodiment, rack 30 includes a pair of clamping assemblies 33 interconnected by a cross brace 37 that is configured to hold the clamping assemblies substantially parallel and spaced from one another in order to provide a stable support for wake boards 31 as is shown in FIG. 1 and FIG. 2. One will appreciate that the distance between clamping assemblies may vary depending upon the particular type of sport equipment. For example, a longer cross brace may be utilized in the event that the rack is intended to hold longer sport equipment such as a surfboard.

One will appreciate that one, two, three or more clamping assemblies may be utilized in accordance with the present invention. In the event that only one clamping assembly is used, the support and clamp members are thick enough to provide a sufficient longitudinal dimension to provide vise-like clamping area to hold the sport equipment within the clamp assembly without the sport equipment pivoting.

A mount 38 is provided on cross brace 37 for securing rack 30 to a watercraft. In the event that a single clamping assembly is used, the mount may be provided on the support member. Preferably, the rack is mounted on boat 32 in a position that does not interfere with passengers moving about the boat or obstruct the driver's and passenger's view, and yet provide ready access to wake boards 31. In the illustrated embodiment, rack 30 is mounted to a tow frame 39 of boat 32, however, one will appreciate that the rack may be secured to the transom, a wall panel and/or other portion of the boat.

Suitable materials for the support members, clamp members, cross brace and/or mount include, but are not limited to metal, plastic and composite materials. For example, the support members, clamp members and cross brace may be formed of CNC-machined aluminum alloy plates. Alternatively, the members may be formed by manufacturing methods including, but not limited to, stamping, molding, forging and/or other known means.

Each support member 34 includes a guide 40 extending from a base 41 along a longitudinal axis A of the support member, as well as a pair of a support prongs 42 extending from the base at an angle with respect to longitudinal axis A. Although the illustrated embodiment includes a pair of support prongs disposed substantially symmetrically about the longitudinal axis to provide support for a pair wake boards, one should appreciate that only one support prong need be provided in the event that the sport equipment rack is configured to hold a single item. Similarly, the support member may be provided with additional support prongs in the event that the rack is configured to hold more than two wake boards. The support prongs may be symmetrically or asymmetrically arranged about the longitudinal axis.

A resilient gripping member 43 is disposed on a support surface 44 of each support prong 42, which support surface faces clamp member 35 as shown in FIG. 2. In the illustrated embodiment, the gripping member includes a series of lugs 45 extending from a strip base 46 of the gripping member that is affixed to support surface 44 of and projecting upwardly toward a wedge surface 47 of clamp member 35. The lugs are dimensioned and configured to flex toward base 41 of the support member as is discussed in greater detail below. One would appreciate that one, two, three or more lugs may be provided and that the lugs may, but need not, be populated along the length of support surface 44. One will further appreciate that the gripping member may consist of a base strip provided that the base strip has sufficient resilience to conform to at least a portion of the contour of wake board 31 when the clamping member is in the closed position.

Suitable materials for the gripping members include, but are not limited to plastic, rubber, and/or other resilient materials. For example, the gripping members may be strips of rubber-like material and be notched to define the plurality of lugs. Alternatively, the gripping members may be molded such that the lugs are monolithically formed with the strip base and/or formed by other suitable means.

The gripping members may be affixed to the support prong by adhesives, fasteners, mechanical means and/or other suitable means. Although the illustrated embodiment shows the gripping members attached to the support surface of the support prong, one will appreciate that the gripping members may instead be affixed to the wedge surface of the clamp member, or sets gripping members may be affixed to support surface of the support member and the wedge surface of the clamp member, respectively.

A clamp member 35 is provided for each support member 34 and is configured to slide along guide 40 between an open position and a secured position. Preferably, the clamp member has a slit 48 complementary in shape to guide 40 of support member 34 in order to provide a linear guide between the clamp member and the support member. One will appreciate that other guide means including, but not limited to, linear bearings, tongue-and-groove configurations, and other suitable guide means may be utilized to provide a suitable slide assembly between the support and clamp members.

Each clamp member may be provided with an auxiliary notch 49. One will appreciate that auxiliary notch 49 may be utilized to support other equipment in a manner similar to that in which prior fork-type racks have been used.

Each clamp member 35 has a wedge surface 47 corresponding to each support surface 44 of the support member. The wedge surface is substantially, but not exclusively, parallel to support surface 44 of support prong 42. In the illustrated embodiment, the support and wedge surfaces are substantially linear, however, one will appreciate that the support surfaces need not be straight and may instead be curved. For example, the support surface may be concave shaped and the wedge surface may have a complementary convex shape. Alternatively, both the support and wedge surfaces may be concave in order to generally conform to the shape of a wake board. Further still, both the support and wedge surfaces may be slightly convex provided that a sufficient portion of the wake board contacts the gripping surface when the clamp member is in the closed position to allow the gripping members to firmly contact and clamp the wake board in place.

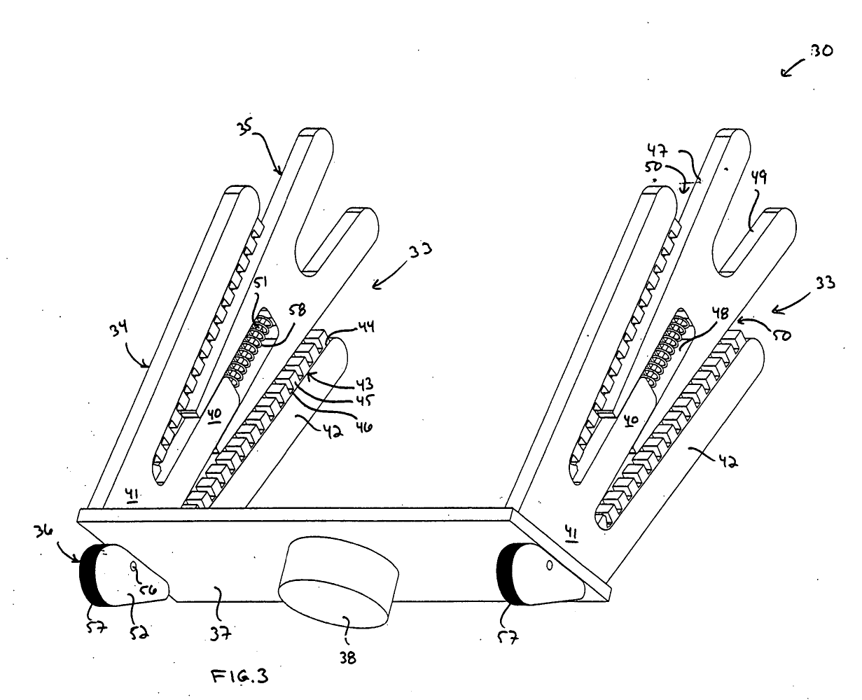

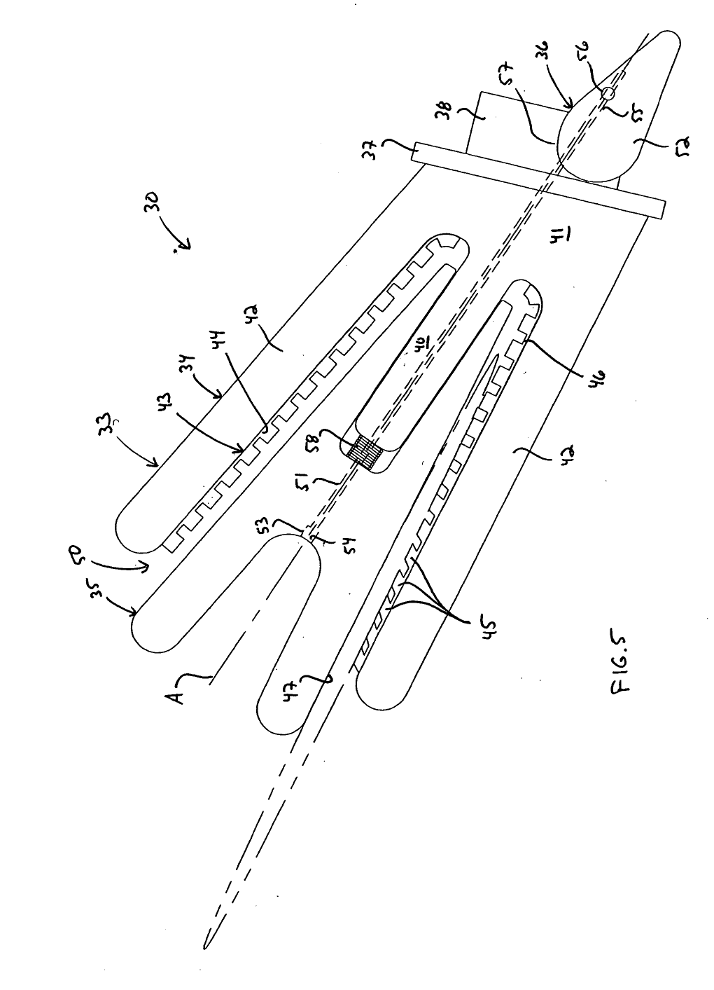

Wedge surface 47 and support surface 44 together define a variable width slot 50 that is dimensioned to be sufficiently wide enough to receive wake board 31 when clamp member 35 is in the open position (FIG. 3), and sufficiently narrow such that the wedge surface biases the wake board against gripping member 43 to elastically deform the gripping member, as is schematically shown in FIG. 5.

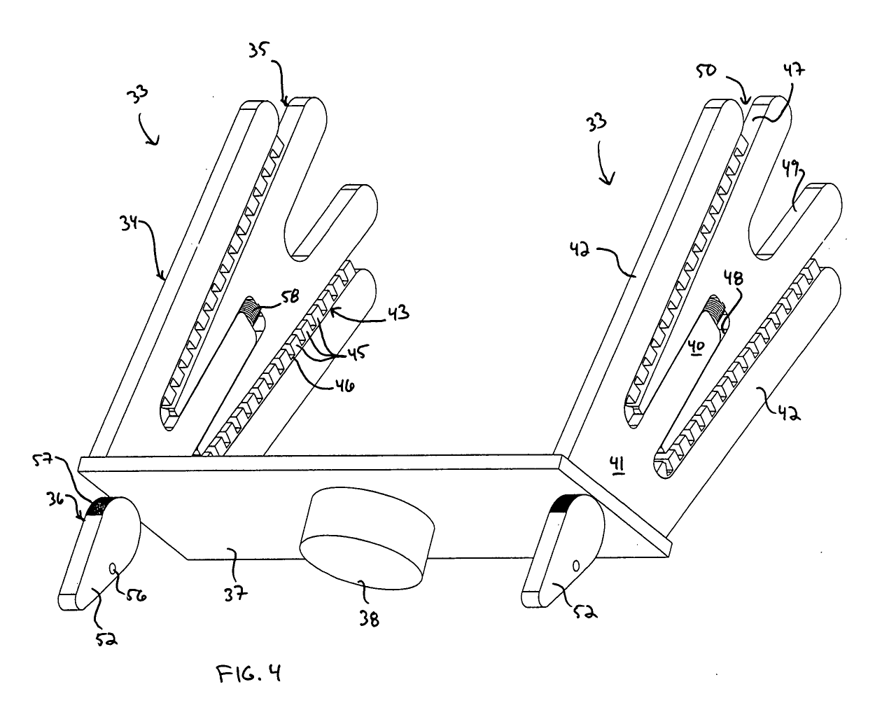

A securing device 36 is provided for each support-member/clamp-member assembly and is configured to move the clamp member between the open and secured positions shown in FIG. 3 and FIG. 4, respectively, whereby the wedge surface is configured to bias sport equipment against gripping member 43 disposed on the support prong (FIG. 5) as the clamp member moves toward the closed position.

In the illustrated embodiment, securing device 36 includes a securing rod 51 that slidably extends through support member 34 and is operably couples a securing lever 52 to clamp member 35. The securing rod may be in the form of an elongated carriage bolt having a bolt head 53 engaging a countersunk bore 54 at the base of auxiliary notch 49 of clamp member 35 and a threaded end 55 adjustably engaging a threaded pin 56 of the securing lever 52. Securing lever 52 includes a cam surface 57 that allows a user to quickly move clamp member 35 between the open and closed positions by simply pivoting the securing lever between the positions shown in FIG. 3 and FIG. 4, respectively. Preferably a spring 58 is provided between support member 34 and clamp member 35 to bias the clamp member toward its open position.

The carriage-bolt/pin configuration of the securing device allows the user to adjust the tightness, that is, the final position of the clamping member. For example, a user may tighten securing device 36 by simply rotating securing lever 52 in a clockwise direction about threaded securing rod 51 and advancing threaded pin 56 along its threaded end 55. Conversely, the user may loosen the securing device by rotating the securing lever counterclockwise.

One will appreciate that other securing means may be utilized to move and secure the clamp member with respect to the support member in accordance with the present invention. For example, the support member may be threaded in which case the carriage bolt is dimensioned and configured to thread directly into the support member. In this case, a user may use a hexagonal wrench to simply tighten the carriage bolt to move the clamp member toward the support member. Alternatively, spring-latch configurations and other suitable means may be utilized to move and secure the clamp member with respect to the support member.

A method of using sport equipment rack 30 in accordance with the present invention can now be described. In operation and use, a user will place move securing lever 52 to the open position (FIG. 3). The user will then place a wake board 31 in one slot 50 and, if desired, another wake board in the other slot. The user will then move securing levers 52 to their closed positions (FIG. 4) thereby moving the clamp members 35 to their closed positions. As each clamp member 35 moves toward its closed position, the clamp member biases wake board 31 toward the corresponding support prong 42 such that the wake board contacts one or more lugs 45 of the corresponding gripping member 43.

In the event that the user determines that the wakeboard is not fully secured, that is, one or both of clamping assemblies 33 is not tight enough, the user may release the respective securing lever 52, rotate the corresponding securing lever clockwise about securing rod 51 to adjustably tighten securing device 36, and again move securing lever 52 to its closed position.

The longitudinal travel of clamp member 35 and the resultant travel of the biased wake board in combination with the angled configuration of support prong 42 causes wake board 31 to flex the contacted lugs toward base 41 of support member 34 as the rack is closed (FIG. 5). Such flexing causes the gripping members to securely wedge the wake board within slot 50. Once the rack is secured, any force tending to displace the wake board outwardly from slot 50, whether caused by choppy water, sudden acceleration or deceleration, or quick turns, will increase the frictional force between wake board 31 and lugs 45. In particular, any outward displacement of wake board 31 will cause similar displacement of the upper ends of lugs 45 and cause the lugs to flex away from base 41 (e.g., see arrow D in FIG. 5). The resulting compression of the lugs against the wake board tends to increase the frictional force between the wakeboard and thus further prevents inadvertent displacement of the wakeboard from the rack.

In order to remove the wakeboard from the rack, the user merely moves the securing levers 52 to their open positions. Springs 58 bias clamp members 35 back to their open positions (FIG. 3) thus allowing the user to remove the wakeboard(s) from rack 30.

For convenience in explanation and accurate definition in the appended claims, the terms “up” or “upper”, “down” or “lower”, “inside” and “outside” are used to describe features of the present invention with reference to the positions of such features as displayed in the figures.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A rack for releasably holding sport equipment comprising:
a support member including a base, a guide extending from said base, and a support prong extending from said base angularly disposed with respect to said guide;
a clamp member movable along said guide between an open position and a secured position, said clamp member having a wedge surface substantially parallel to said support prong; and
a securing device configured to move said clamp member between said open and secured positions, whereby said wedge surface is configured to bias sport equipment against said support prong as the clamp member moves toward said closed position.

2. A rack according to claim 1, wherein said rack is dimensioned and configured to hold a wake board, a knee board, a surf board, and/or water skis.

3. A rack according to claim 1, wherein said support member comprises a pair of said support prongs and said clamp member comprises a corresponding pair of said wedge surfaces.

4. A rack according to claim 3, wherein said pair of support prongs are substantially symmetrically arranged about said guide and said pair of wedge surfaces are substantially symmetrically arranged about said guide.

5. A rack according to claim 1, wherein said rack comprises a pair of said support members and a corresponding pair of clamp members, said rack further comprising a cross brace having two ends, each said supporting member attached to said cross brace adjacent a respective end.

6. A rack according to claim 5, wherein said rack further comprises a mount for securing said rack to a watercraft, said mount disposed on said cross brace intermediate said ends.

7. A rack according to claim 1, wherein said rack further comprises a resilient gripping member disposed on said support prong facing said wedge surface.

8. A rack according to claim 7, wherein said gripping member includes a lug extending toward said wedge surface when said clamp member is in said open position, and configured to flex toward said base as said clamp member is moved to said closed position.

9. A rack according to claim 8, wherein said gripping member includes a plurality of said lugs.

10. A rack according to claim 9, wherein said securing device includes a securing lever and a securing rod secured to said securing lever, extending through said support member and operably coupled to said clamp member.

11. A rack according to claim 10, wherein said closed position is adjustable to accommodate sport equipment of various widths.

12. A rack according to claim 11, wherein said securing rod has a threaded end adjustably coupled to a threaded pin of said securing lever.

13. A rack for releasably holding sport equipment comprising:
a support member having a longitudinal axis and including a base, a guide extending along said longitudinal axis from said base, and a support prong extending from said base at an angle with respect to said longitudinal axis;
a clamp member movable along said guide between an open position and a secured position, said clamp member having a wedge surface substantially parallel to said support prong defining a variable width slot between said wedge surface and said support prong dimensioned to receive the sport equipment;
a resilient gripping member disposed on said support prong facing said wedge surface; and
a securing device configured to move said clamp member between said open and secured positions, whereby said wedge surface is configured to bias sport equipment against said support prong as the clamp member moves toward said closed position.

14. A rack according to claim 13, wherein said rack is dimensioned and configured to hold a wake board, a knee board, a surf board, and/or water skis.

15. A rack according to claim 13, wherein said support member comprises a pair of said support prongs and said clamp member comprises a corresponding pair of said wedge surfaces.

16. A rack according to claim 15, wherein said pair of support prongs are substantially symmetrically arranged about said longitudinal axis and said pair of wedge surfaces are substantially symmetrically arranged about said longitudinal axis.

17. A rack according to claim 13, wherein said rack comprises a pair of said support members and a corresponding pair of clamp members, said rack further comprising a cross brace having two ends, each said supporting member attached to said cross brace adjacent a respective end.

18. A rack according to claim 17, wherein said rack further comprises a mount for securing said rack to a watercraft, said mount disposed on said cross brace intermediate said ends.

19. A rack according to claim 13, wherein said gripping member includes a lug extending toward said wedge surface when said clamp member is in said open position, and configured to flex toward said base as said clamp member is moved to said closed position.

20. A rack according to claim 19, wherein said gripping member includes a plurality of said lugs.

21. A rack according to claim 20, wherein said securing device includes a securing lever and a securing rod secured to said securing lever, extending through said support member and operably coupled to said clamp member.

22. A rack according to claim 21, wherein said closed position is adjustable to accommodate sport equipment of various widths.

23. A rack according to claim 22, wherein said securing rod has a threaded end adjustably coupled to a threaded pin of said securing lever.
